(19) United States
(12) Patent Application Publication
(10) Pub. No.: US 2013/0010496 A1
(43) Pub. Date: Jan. 10, 2013

(54) LED BACKLIGHT

(75) Inventors: Katsuhiko Higashi, Osaka-shi (JP); Kohji Yabuta, Osaka-shi (JP); Mikihiro Noma, Osaka-shi (JP); Takehiro Murao, Osaka-shi (JP)

(73) Assignee: SHARP KABUSHIKI KAISHA, Osaka (JP)

(21) Appl. No.: 13/637,114

(22) PCT Filed: Jan. 24, 2011
(86) PCT No.: PCT/JP2011/051201

§ 371 Date: Sep. 25, 2012

(30) Foreign Application Priority Data
Apr. 7, 2010 (JP) 2010-088604

(51) Int. Cl. F21V 8/00

(52) U.S. Cl. 362/609

(57) ABSTRACT

In an edge-light type LED backlight in which visible light LED light sources and non-visible light LED light sources are mounted on a FPC in a side-view type manner and light enters a light guide plate through a side surface, in order that visible light and non-visible light are efficiently guided into the light guide plate and the efficiency of light emission is enhanced, reflective members and that reflect and guide both the visible light and the non-visible light to an entrance portion are provided on a first surface side corresponding to the mounting surface side of the FPC and a second surface side corresponding to the back surface side of the FPC.

### TECHNICAL FIELD

The present invention relates to an LED backlight that is used in a liquid crystal display device or the like.

### BACKGROUND ART

In recent years, as light emission efficiency and light emission amount have been increased, an illumination device using an LED (light-emitting diode) that has a long life and a low power consumption and is environmentally friendly has been commercially used. As a backlight of a liquid crystal display device or the like, an edge-light type backlight is used in which a plurality of LED light sources are arranged on a side surface portion of a light guide plate having a planar light emission surface.

This edge-light type backlight has a configuration in which a large number of LED light sources, each serving as a point light source, are arranged on the side surface portion of the light guide plate. Hence, when variations in the brightness of the LED light sources are produced, since the brightness of light entering the light guide plate varies and thus the brightness of light emitted from the light emission surface varies, it is important to equalize the brightness of the LED light sources so that the brightness of light emitted from the light emission surface is made uniform.

In the method of mounting LED light sources, a so-called top-view type LED light source that emits light toward a front surface with respect to a mounting surface and a so-called side-view type LED light source that emits light in a lateral direction with respect to the mounting surface are known. As a substrate on which the LED light sources are mounted, a rigid substrate or a flexible substrate (flexible printed substrate: referred to as a FPC) is used.

Hence, in an edge-light type backlight in which the LED light sources are mounted on the rigid substrate in the top-view type manner, the rigid substrate is arranged parallel to the side surface of the light guide plate, and the LED light sources mounted on this rigid substrate are arranged opposite the side surface portion of the light guide plate that serves as the entrance portion of light. On the other hand, in an edge-light type backlight in which the LED light sources are mounted on the FPC in a side-view type manner, the FPC is arranged parallel to the light emission surface of the light guide plate, and the LED light sources mounted on the FPC are arranged opposite the side surface portion of the light guide plate that serves as the entrance portion of light.

As a backlight light source, a white LED light source which uses LED chips of three primary colors, that is, blue, green and red and which emits white light, a white LED light source in which a blue LED chip and a yellow fluorescent member constitute a light source to emit white light and a white LED light source in which a blue LED chip, a green fluorescent member and a red fluorescent member constitute a light source to emit white light are used. Furthermore, in order to configure a touch panel type display device, a backlight is used in which display light sources using a white LED light source and detection light sources using an infrared LED light source emitting infrared light are placed to be mixed.

Since infrared light is non-visible light, it can be used as light for detecting a finger of a person or an input pen that touches a display screen without any influence on an image displayed on the display screen. Hence, in the touch panel type backlight described above, a large number of display light sources and detection light sources are arranged on the side end portion of the light guide plate.

In the edge-light type backlight described above, in order to make uniform the brightness distribution of a light emission surface and obtain a high-quality display device, it is preferable to equalize the brightness of light emitted from the LED light sources of the display light sources and the detection light sources and enhance the light emission efficiency of the LED light sources.

In the edge-light type backlight, in order to enhance the light emission efficiency of the LED light sources, it is preferable to make light emitted from the LED light sources enter the light guide plate without any leakage. Hence, a point light source backlight device has already been suggested in which, on the upper surface and the lower surface of the side end portion of the light guide plate where the LED light sources are arranged, an upper reflective plate and a lower reflective plate are respectively provided, the light emitted from the LED light sources is efficiently guided into the light guide plate and the brightness distribution of the light emission surface is made uniform (for example, see patent document 1).

### RELATED ART DOCUMENT

### Patent Document

Patent document 1: JP-A-2007-128748

### DISCLOSURE OF THE INVENTION

### Problems to be Solved by the Invention

In a general display device backlight, white LED light sources in the visible light region are used, and a reflective plate for efficiently reflecting white light emitted from the white LED light sources is used. However, in a backlight having display white LED light sources and detection infrared LED light sources, since it is insufficient to efficiently reflect only visible light, it is preferable to efficiently reflect infrared light, which is non-visible light, too.

The backlight device disclosed in patent document 1 is the so-called top-view type LED light source that emits light toward the front surface with respect to the mounting surface of the LED, and the substrate is arranged parallel to the side end surface of the light guide plate. This facilitates that reflective plates are provided parallel to the upper surface and the lower surface of the light guide plate, and that the substrate of a rigid type LED light source is arranged to be sandwiched between these upper and lower reflective plates.

However, since, in the backlight where the side-view type LED light sources using the FPC are arranged, the FPC is so arranged as to be parallel to any one of the upper surface and the lower surface of the light guide plate, light disadvantageously leaks from the FPC portion.

As described above, in the edge-light type backlight in which the display visible light LED light sources and the detection non-visible light LED light sources are fitted to the FPC, it is preferable to efficiently reflect not only the light that leaks from the side of the LED light sources mounted on the FPC but also visible light and non-visible light that transmit the FPC and leak and introduce them into the light guide plate.

In view of the forgoing problem, an object of the present invention is to provide an LED backlight that efficiently guides, in an edge-light type backlight using a FPC in which visible light LED light sources and non-visible light LED light sources are mounted in a side-view type manner, the visible light and the non-visible light into the light guide plate, and that can enhance light emission efficiency.

### Means for Solving the Problem

To achieve the above object, according to the present invention, there is provided an LED backlight including: a light guide plate that has a planar light emission surface in an upper surface and an entrance portion of light in a side surface; and a FPC that incorporates a light source portion on which a visible light LED light source emitting light toward the side surface and a non-visible light LED light source are mounted in a side-view type manner, in which, in the edge-light type LED backlight where the FPC is arranged parallel to the light emission surface, the light source portion is arranged opposite the side surface and light enters the light guide plate through the side surface, a reflective member that reflects and guides both the visible light and the non-visible light into the entrance portion is provided on each of a first surface side on an outside of the light source portion corresponding to a mounting surface side of the FPC and a second surface side corresponding to a back surface side of the FPC.

In the configuration described above, even when the visible light LED light sources and the non-visible light LED light sources are provided on the side portion of the light guide plate, and light enters the light guide plate through the side portion, it is possible to reduce the leakage of light from the entrance portion to portions other than the light guide plate, that is, the leakage of both visible light and non-visible light from the front surface side and the back surface side of the FPC on which the LED light sources for visible light and non-visible light are mounted, with the result that it is possible to efficiently guide all light into the light guide plate and to obtain the LED backlight in which the efficiency of light emission is enhanced.

In the LED backlight according to the present invention and configured as described above, a reflective member on any one of the first surface side and the second surface side shares a reflective sheet arranged on a back surface opposite the light emission surface of the light guide plate. In this configuration, it is possible to obtain the LED backlight in which the reflective surface of the light guide plate efficiently reflects both visible light and non-visible light and the light can be efficiently emitted from a planar light-emitting member.

In the LED backlight according to the present invention and configured as described above, a plurality of the visible light LED light sources and the non-visible light LED light sources are alternately arranged. In this configuration, even when a plurality of types of LED light sources are arranged to be mixed on the FPC, since any type of light is efficiently reflected, it is possible to effectively utilize the light emitted from the LED light sources, with the result that it is possible to obtain the LED backlight in which light emission efficiency is enhanced.

In the LED backlight according to the present invention and configured as described above, a non-visible light LED package forming the non-visible light LED light source and a visible light LED package forming the visible light LED light source are configured by incorporating a predetermined light-emitting member including light-emitting elements emitting light of predetermined colors and a fluorescent member in a common package. In this configuration, since the common package is used to manufacture the visible light LED light source and the non-visible light LED light source, it is possible to manufacture both of the LED light sources with any one of the mass-manufactured LED packages, with the result that it is possible to reduce the manufacturing cost.

In the LED backlight according to the present invention and configured as described above, the visible light is white light, the non-visible light is infrared light, the visible light LED light source is a white LED light source and the non-visible light LED light source is an infrared LED light source. In this configuration, it is possible to obtain the LED backlight that can effectively guide both white light and infrared light. It is therefore possible to enhance the efficiency of light emission without the intensities of light emission of the LEDs of both the white LED light sources and the infrared LED light sources.

In the LED backlight according to the present invention and configured as described above, the white LED light source is formed with a white LED package that includes a light-emitting portion emitting white light and a component emitting the white light in a predetermined direction and that is packaged, the infrared LED light source utilizes the white LED package and a light-emitting member emitting infrared light is incorporated by replacing a light-emitting member emitting the white light. In this configuration, since it is possible to manufacture the infrared LED package with the mass-manufactured white LED package, it is possible to manufacture the infrared LED package at low cost.

In the LED backlight according to the present invention and configured as described above, the reflective member is a silver reflective sheet that has a high reflectivity for the white light and a high reflectivity for the infrared light. In this configuration, it is possible to obtain the LED backlight in which the reflective member that efficiently reflects both white light that is visible light and infrared light that is non-visible light is used to efficiently guide the visible light and the non-visible light into the light guide plate and in which the light emission efficiency can be enhanced.

### Advantages of the Invention

According to the present invention, in the edge-light type LED backlight fitted with the FPC on which the visible light LED light sources and the non-visible light LED light sources are mounted in the side-view type manner, since the reflective member that reflects and guides both the visible light and the non-visible light to the entrance portion provided on the side portion of the light guide plate is provided on each of the first surface side opposite the FPC and the second surface side corresponding to the back surface of the FPC, it is possible to obtain the LED backlight that can efficiently guide the visible light and the non-visible light into the light guide plate and that can enhance the efficiency of light emission of the LEDs.

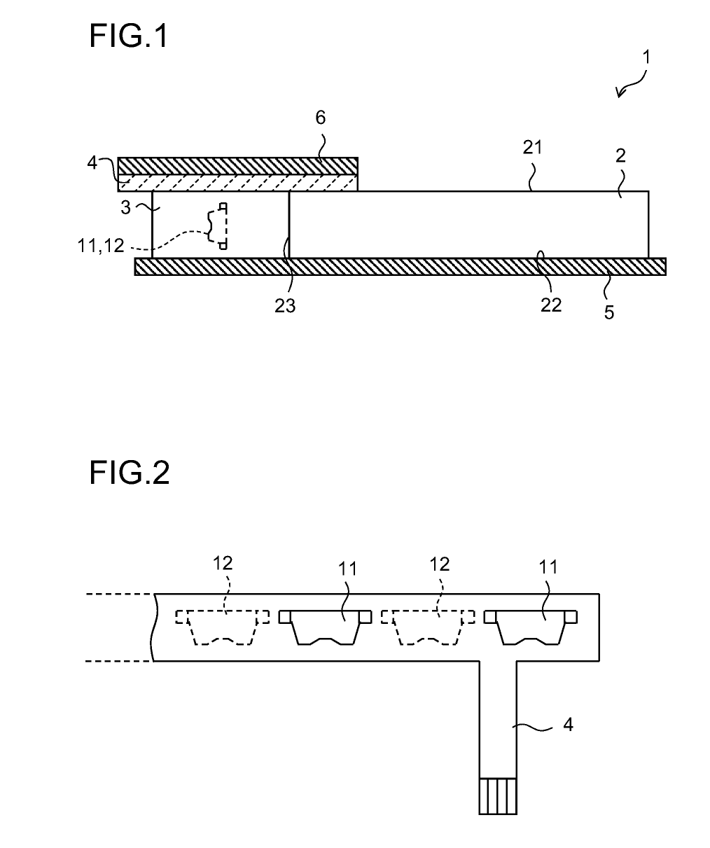

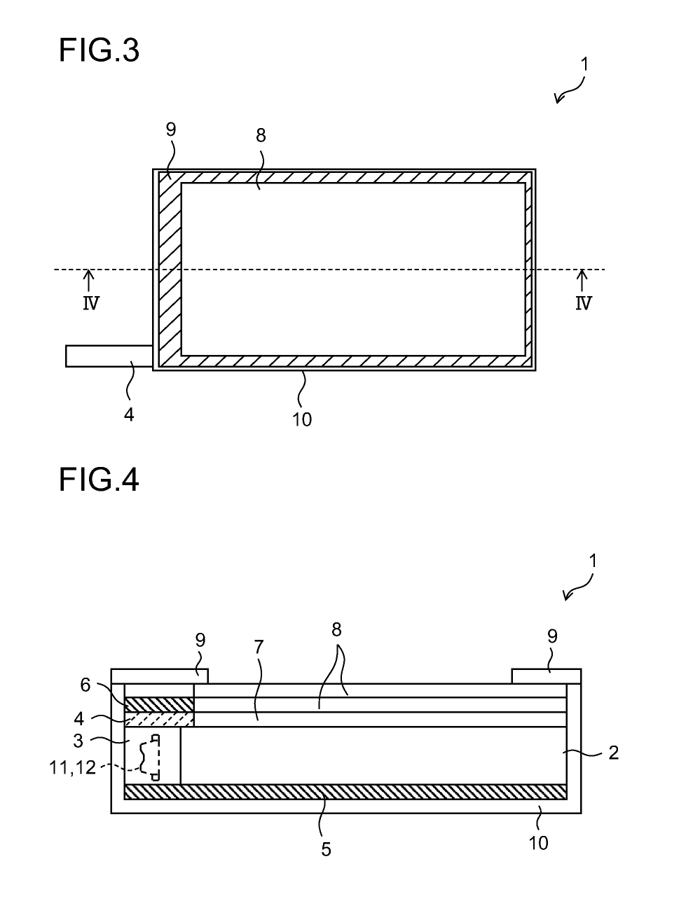

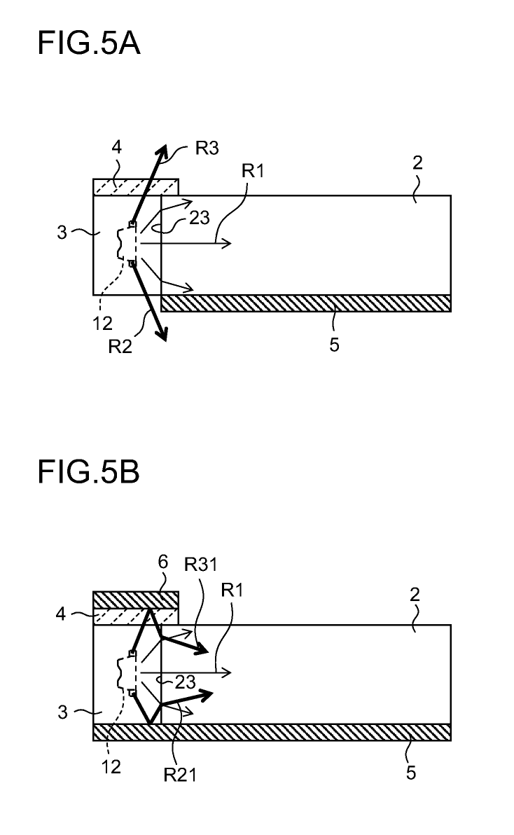

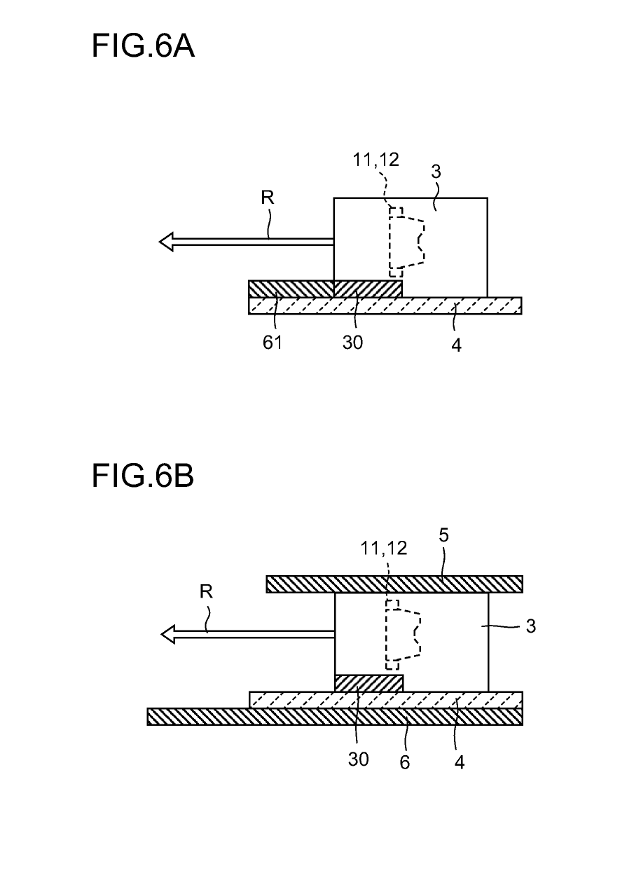

### BRIEF DESCRIPTION OF DRAWINGS

[FIG. 1] A schematic cross-sectional view showing the configuration of main portions of an LED backlight according to the present invention;

[FIG. 2] A schematic illustrative view showing an example of the incorporation of an LED light source mounted on a FPC;

[FIG. 3] A schematic overall plan view of the LED backlight according to the present invention;

[FIG. 4] A schematic cross-sectional view of the LED backlight according to the present invention;

[FIG. 5A] A schematic view illustrating an example of a conventional configuration where light emission efficiency is poor;

[FIG. 5B] A schematic view illustrating an example of the configuration of the present invention where light emission efficiency is enhanced;

[FIG. 6A] A schematic illustrative view showing a first variation for reducing the leakage of light from a FPC portion; and

[FIG. 6B] A schematic illustrative view showing an example of the configuration of the present invention for reducing the leakage of the light from the FPC portion.

### DESCRIPTION OF EMBODIMENTS

An embodiment of the present invention will be described below with reference to accompanying drawings. Like constituent members are identified with like symbols, and their detailed description will be omitted as appropriate.

An example of an LED backlight according to the present embodiment will be described with reference to FIG. 1.

The LED backlight 1 shown in FIG. 1 is an edge-light type LED backlight fitted with a FPC 4 on which visible light LED light sources 11 and non-visible light LED light sources 12 are mounted in a side-view type manner. The LED backlight 1 is also a planar light-emitting member in which the upper surface of a light guide plate 2 is a planar light emission surface; in the present embodiment, the upper surface 21 of the light guide plate 2 is the light emission surface, and a side surface 23 is an entrance portion.

For example, the FPC 4 is arranged parallel to the light emission surface of the light guide plate 2; a light source portion 3 on which the visible light LED light sources 11 and the non-visible light LED light sources 12 are mounted is arranged opposite the side surface 23. As described above, the LED backlight 1 of the present embodiment is an edge-light type LED backlight in which the entrance portion of light is provided on the side surface 23 of the light guide plate 2 forming the planar light-emitting member, the FPC 4 is arranged parallel to the light emission surface of the light guide plate 2 such that the light source portion 3 on which the visible light LED light sources 11 and the non-visible light LED light sources 12 are mounted in the side-view type manner on the entrance portion is opposite the side surface 23 and light enters the light guide plate through the side surface 23 of the light guide plate.

The visible light LED light source 11 is, for example, a white LED light source that emits white light; the non-visible light LED light source 12 is, for example, an LED light source that emits infrared light. Since infrared light is non-visible light, it can be used as light for detecting a finger of a person or an input pen that touches a display screen without any influence on an image displayed on the display screen. Hence, the backlight incorporating the white LED light sources and the infrared LED light sources can be suitably applied to, for example, a touch panel type display device.

As shown in FIG. 2, on the FPC 4 of the present embodiment, a plurality of visible light LED light sources 11 and non-visible light LED light sources 12 are alternately mounted with a predetermined pitch. In other words, on the FPC 4, which is a flexible substrate, the white LED light sources and the infrared LED light sources are placed to be mixed. Thus, the LED backlight 1 of the present embodiment can uniformly emit both visible light and non-visible light over the entire planar light emission surface of the light guide plate 2.

Since the FPC 4 uses a flexible thin base material formed of resin, the FPC 4 transmits part of light. Hence, the visible light emitted by the visible light LED light sources 11 and the non-visible light emitted by the non-visible light LED light sources 12 leak from the FPC portion, and thus the light entering the light guide plate 2 is reduced. As described above, part of the light emitted from the LED light sources leaks, and thus the intensity of light emission of the LED light sources is reduced.

Since visible light and non-visible light have a different wavelength of light, a reflective member that efficiently reflects visible light not necessarily reflects non-visible light efficiently. In particular, a reflective film formed of a polyester resin used for efficiently reflecting visible light (about 400 to 800 nm) has a low reflectivity for infrared light (for example, 850 to 950 nm); when this reflective film is used as the reflective member, it efficiently reflects visible light but cannot efficiently reflect infrared light, with the result that the efficiency of light emission of infrared light is reduced.

Hence, in the present embodiment, as shown in FIG. 1, on the back surface side of the FPC 4, a reflective film 6 that has the function of efficiently reflecting both visible light and non-visible light is provided. On the outside of the light source portion 3 that is the mounting surface side of the FPC 4, a reflective film 5 that has the function of efficiently reflecting both visible light and non-visible light is also provided. As described above, the LED backlight 1 of the present embodiment includes the reflective member reflecting both the visible light and the non-visible light and guiding them to the entrance portion of the light guide plate 2, on each of a first surface side corresponding to the mounting surface side of the FPC 4 and a second surface side corresponding to the back surface side of the FPC 4.

In the configuration described above, even when the visible light LED light sources and the non-visible light LED light sources are provided on the side portion of the light guide plate 2, and light enters the light guide plate 2 through the side portion, it is possible to reduce the leakage of light from the entrance portion to portions other than the light guide plate, that is, the leakage of both visible light and non-visible light from the front surface side and the back surface side of the FPC 4 on which the LED light sources for visible light and non-visible light are mounted, with the result that it is possible to efficiently guide all light into the light guide plate and to obtain the LED backlight 1 in which the efficiency of light emission is enhanced without the intensity of light emission being reduced.

When a reflective sheet is provided on the back surface of the light guide plate 2, this reflective sheet may be formed of a material that reflects both visible light and non-visible light, and the reflective sheet may be provided to extend up to the portion of the FPC 4. As described above, when the reflective member on any one of the first surface side and the second surface side shares the reflective sheet provided on the back surface opposite the light emission surface of the light guide plate 2, since the reflective surface on the back surface of the light guide plate 2 efficiently reflects both visible light and non-visible light, it is possible to obtain the LED backlight that can efficiently emit light from the planar light-emitting member.

The overall configuration of the LED backlight 1 will now be described with reference to FIGS. 3 and 4. FIG. 3 is a schematic overall plan view of the LED backlight 1; FIG. 4 shows a cross-sectional view taken along line IV-IV of FIG. 3.

As shown in FIG. 3, the LED backlight 1 of the present embodiment is an illumination device that is rectangular when seen in plan view. As shown in FIG. 4, the LED backlight 1 is formed by placing the following components on a frame-shaped chassis 10 in this order: the light guide plate 2, a diffusion sheet 7, a lens sheet 8 and a RIM sheet 9. A liquid crystal display device is formed by placing, for example, a liquid crystal panel on it.

The diffusion sheet 7 and the lens sheet 8 are optical members that make uniform light emitted from the light emission surface of the light guide plate 2 and that enhance the brightness thereof; the RIM sheet 9 is a frame-shaped light-blocking sheet that is formed of, for example, a PET resin (polyethylene terephthalate) and that prevents light from leaking from the perimeter portion.

The leakage of light from the entrance portion of light will now be described with reference to FIGS. 5A and 5B.

FIG. 5A shows a state where light leaks from the portion of the FPC 4; FIG. 5B shows a state where the reflective member 5 is provided on the outside surface of the light source portion 3 mounted on the FPC 4, that is, the first surface side corresponding to the front surface side of the FPC that is the mounting surface side of the FPC, the reflective member 6 is provided on the second surface side corresponding to the back surface side of the FPC and the leakage of the light from the portion of the FPC 4 is reduced.

FIG. 5A shows that, for example, as light emitted from the non-visible light LED light sources 12 that are the infrared LED light sources, entrance light R1 that directly enters the light guide plate 2 through the side surface 23, light R2 that leads from the first surface side on the surface of the light source portion 3 corresponding to the front surface side of the FPC 4 and light R3 that leaks from the second surface side corresponding to the back surface side of the FPC 4 are present.

In this state, the leakage light R2 and the leakage light R3 are the reduced light, and only the intensity of light whose output is decreased can be utilized with respect to the intensity of the light output by the non-visible light LED light sources 12. Hence, in the present embodiment, in order to efficiently utilize the leakage light R2 and the leakage light R3, the reflective members 5 and 6 that reflect both the visible light and the non-visible light and that guide them to the entrance portion are provided.

In the reflective members, when infrared light having, for example, a wavelength of about 850 to 950 nm is employed as the non-visible light, it is preferable to use a silver reflective sheet that has a high reflectivity for both light in a visible light region of a wavelength of 400 to 800 nm and light in an infrared region of a wavelength of about 850 to 950 nm. As the silver reflective sheet, a conventionally known optical silver reflective sheet can be used.

As shown in FIG. 5B, when the LED light source is mounted, in the side-view type manner, on the FPC 4 arranged parallel to the light emission surface of the light guide plate 2, the reflective members 5 and 6 are respectively provided on the first surface side corresponding to the mounting surface side of the FPC 4 and the second surface side corresponding to the back surface side of the FPC, and thus the leakage light R2 from the first surface side becomes the entrance light R21 that is reflected off the reflective film 5 to enter the light guide plate 2, and the leakage light R3 from the second surface side becomes the entrance light R31 that is reflected off the reflective film 6 to enter the light guide plate 2.

Since it is obvious that all visible light emitted from the visible light LED light sources 11 arranged to be mixed with the non-visible light LED light sources 12 also enters the light guide plate 2 through the reflective members 5 and 6, the LED backlight 1 of the present embodiment is used, and thus it is possible to effectively utilize the light emitted from the visible light LED light sources and the non-visible light LED light sources and to enhance the efficiency of light emission without the intensities of the visible light and the non-visible light being reduced.

Since the light emitted from the LED light sources is reflected off the reflective members arranged around the packaged LED light sources, and is made to enter the light guide plate, it is not necessary to configure a package that accurately specifies the reflective characteristic of predetermined light in the LED light sources.

Specifically, even when components such as a substrate on which light-emitting elements are mounted and a reflector are used in common, predetermined light emission characteristics can be produced. Hence, a package used in one of the LED light sources is utilized, and light-emitting members that emit the light of predetermined colors are replaced and incorporated, and thus the LED light sources of predetermined light emission colors can be produced. For example, in the package used in one of the LED light sources that is manufactured inexpensively by being mass-manufactured, the light-emitting member of this LED light source is replaced by the light-emitting member of the other LED light source, and thus it is also possible to manufacture the other LED light source inexpensively.

Hence, in the LED backlight in which the mass-manufactured white LED light sources and infrared LED light sources are arranged to be mixed, the infrared LED light source is preferably configured utilizing the white LED package forming the white LED light source. As described above, when the white LED package that is packaged to have a light-emitting portion emitting white light and a component emitting this white light in a predetermined direction is utilized, the light-emitting member emitting white light is replaced by the light-emitting member emitting infrared light and is incorporated and thus the infrared LED light source is manufactured, since it is possible to manufacture the infrared LED package with the mass-manufactured white LED package, it is possible to manufacture the infrared LED package at low cost.

As described above, in order to reduce the cost, it is preferable to configure the non-visible light LED package forming the non-visible light LED light source and the visible light LED package forming the visible light LED light source by incorporating the predetermined light-emitting member including the light-emitting elements emitting the light of predetermined colors and a fluorescent member in the common package.

As described above, even when the visible light LED light sources and the non-visible light LED light sources are arranged in the entrance portion of light of the edge-light type LED backlight, the reflective members for reducing the leakage of both the visible light and the non-visible light from the front surface side and the back surface side of the FPC on which these LED light sources are mounted are used, and thus it is possible to efficiently guide all the light into the light guide plate and to obtain the LED backlight in which the light emission efficiency is enhanced.

The method of reducing the leakage of light from the FPC will now be described with reference to FIGS. 6A and 6B.

FIG. 6A shows a first variation that is expected to reduce the leakage of light from the FPC portion. In this variation, a silver reflective sheet 61 is arranged as the reflective member on the mounting surface of the LED light source of the FPC 4.

Although, even in this configuration, it is considered that the leakage of the light from the FPC 4 can be reduced, and the light can be reflected in the R direction of the emitted light, since the following failure is encountered, it is not preferable. First, there is a possibility that the silver reflective sheet 61 arranged on the mounting surface makes contact with an LED electrode portion 30, a land portion and the like to electrically develop a short circuit. Secondly, it is impossible to reduce the leakage of light from the back surface portion of the LED light source. Thirdly, there is a possibility that interference with the LED emission surface occurs to block the emitted light R.

Hence, in the present embodiment, as shown in FIG. 6B, the reflective member 6 formed with the silver reflective sheet is arranged to cover the entire back surface side of the FPC 4.

In this configuration, there is no possibility that this silver reflective sheet makes contact with the LED electrode portion 30, the land portion and the like to electrically develop a short circuit, it is possible to reduce the leakage of light from the back surface portion of the LED light source and there is no possibility that interference with the LED emission surface occurs to block the emitted light R.

Since, on the front surface side opposite the FPC 4, the reflective member 5 formed with the silver reflective sheet is arranged, in the edge-light type LED backlight, it is possible to effectively reduce the leakage of light (visible light: white light and non-visible light: both types of infrared light) from the entrance portion of light, and it is possible to obtain the LED backlight that can effectively utilize the light emitted from these light sources.

Hence, it is possible to achieve effective utilization of light including non-visible light such as infrared light in which difficulty is produced if a reflective film formed of a polyester resin that efficiently reflects visible light is used.

As described above, according to the present invention, in the edge-light backlight using the FPC on which the visible light LED light sources and the non-visible light LED light sources are mounted in the side-view type manner, the reflective members that reflect both the visible light and the non-visible light are arranged on the outside (first surface side) of the light source portion mounted on the FPC and the back surface side (second surface side) of the FPC, and thus it is possible to obtain the LED backlight that can efficiently guide the visible light and the non-visible light into the light guide plate and that can enhance the light emission efficiency.

In the LED backlight in which the white LED light sources and the infrared LED light sources are arranged to be mixed, the silver reflective sheet that efficiently reflects both white light and infrared light is used, and thus it is possible to obtain the LED backlight that enhances the light emission efficiency without the intensities of light emission of the white LED light sources and the infrared LED light sources being reduced.

Furthermore, the silver reflective sheet that efficiently reflects both white light and infrared light is used, and thus it is possible to manufacture the infrared LED light sources utilizing the white LED light source package, with the result that it is possible to reduce the manufacturing cost of the LED light sources.

### INDUSTRIAL APPLICABILITY

Hence, the LED backlight of the present invention can be suitably utilized as an LED backlight incorporating a plurality of LED light sources emitting the light of different colors.

### LIST OF REFERENCE SYMBOLS

1 LED backlight

2 light guide plate

3 light source portion

4 FPC (flexible printed substrate)

5 reflective member

6 reflective member

11 visible light LED light source (white LED light source)

12 non-visible light LED light source (infrared LED light source)

R1 entrance light

R2 light (leakage light)

R21 entrance light

R3 light (leakage light)

1. An LED backlight comprising:
a light guide plate that has a planar light emission surface in an upper surface and an entrance portion of light in a side surface; and
a FPC that incorporates a light source portion on which a visible light LED light source emitting light toward the side surface and a non-visible light LED light source are mounted in a side-view type manner,
wherein, in the edge-light type LED backlight where the FPC is arranged parallel to the light emission surface, the light source portion is arranged opposite the side surface and light enters the light guide plate through the side surface,
a reflective member that reflects and guides both the visible light and the non-visible light into the entrance portion is provided on each of a first surface side on an outside of the light source portion corresponding to a mounting surface side of the FPC and a second surface side corresponding to a back surface side of the FPC.

2. The LED backlight of claim 1,
wherein a reflective member on any one of the first surface side and the second surface side shares a reflective sheet arranged on a back surface opposite the light emission surface of the light guide plate.

3. The LED backlight of claim 1,
wherein a plurality of the visible light LED light sources and the non-visible light LED light sources are alternately arranged.

4. The LED backlight of claim 1,
wherein a non-visible light LED package forming the non-visible light LED light source and a visible light LED package forming the visible light LED light source are configured by incorporating a predetermined light-emitting member including light-emitting elements emitting light of predetermined colors and a fluorescent member in a common package.

5. The LED backlight of claim 1,
wherein the visible light is white light, the non-visible light is infrared light, the visible light LED light source is a white LED light source and the non-visible light LED light source is an infrared LED light source.

6. The LED backlight of claim 5,
wherein the white LED light source is formed with a white LED package that includes a light-emitting portion emitting white light and a component emitting the white light in a predetermined direction and that is packaged, the infrared LED light source utilizes the white LED package and a light-emitting member emitting infrared light is incorporated by replacing a light-emitting member emitting the white light.

7. The LED backlight of claim 5,
wherein the reflective member is a silver reflective sheet that has a high reflectivity for the white light and a high reflectivity for the infrared light.
